(19) United States
(12) Patent Application Publication
(10) Pub. No.: US 2016/0280006 A1
(43) Pub. Date: Sep. 29, 2016

(54) Arrangement of a Brake Disk on a Wheel Hub

(71) Applicant: KNORR-BREMSE Systeme fuer Nutzfahrzeuge GmbH, Muenchen (DE)

(72) Inventor: Wolfgang PAHLE, Bad Wiessee (DE)

(21) Appl. No.: 15/174,012

(22) Filed: Jun. 6, 2016

Related U.S. Application Data
(63) Continuation of application No. PCT/EP2014/076162, filed on Dec. 2, 2014.

(30) Foreign Application Priority Data
Dec. 5, 2013 (DE) 10 2013 113 550.1

(51) Int. Cl. B60B 27/00; F16D 65/12

(52) U.S. Cl. CPC B60B 27/0052; F16D 65/123; B60B 27/001; F16D 2065/1384

(57) ABSTRACT

The invention relates to an arrangement of a brake disk on a wheel hub of a utility vehicle, wherein the wheel hub has a hub body, which accommodates at least one rolling-element bearing, and a wheel carrier. Said arrangement is designed in such a way that the wheel carrier is designed as a component that is separate from the hub body and connected to the hub body and the wheel carrier has a neck segment that at least partially surrounds the huh body, on which neck segment the brake disk is retained in such a way that the brake disk is rotationally secured in the circumferential direction in a form closed manner, wherein the wheel carrier has an inner ring extending radially, which ring has passage holes for screws, which are screwed into end-face threaded holes of the axle body.

### CROSS REFERENCE TO RELATED APPLICATIONS

This application is a continuation of PCT International Application No. PCT/EP2014/07616, filed Dec. 2, 2014, which claims priority under 35 U.S.C. §119 from German Patent Application No. 10 2013 113 550.1, filed Dec. 5, 2013, the entire disclosures of which are herein expressly incorporated by reference.

### BACKGROUND AND SUMMARY OF THE INVENTION

The invention relates to an arrangement of a brake disk on a wheel hub.

In order to connect a brake disk to a heel hub in a torsion-resistant manner, different constructions are known. There are thus used connections in which the brake disk has a pot-like attachment with a radial flange face which is secured to the end face of a hub body by means of a screw connection.

In this instance, the wheel carrier is in abutment with brake disk at the side of the flange opposite the hub body and is connected to the hub body by means of the screw connection of the brake disk pot-like member, that is to say, the brake disk is clamped between the hub body and the wheel carrier.

During operation, in particular when traveling round bends, not only peripheral forces in the form of torque, but also transverse forces act on the wheel carrier or the screw connection, which is thereby loaded to an extraordinarily high level.

The more separation locations a screw connection has, the greater the risk that the screw connection may become released, which is naturally a problem which is in principle unacceptable.

Furthermore, via the pot-like attachment of the brake disk, the heat which is generated during the braking operation is transmitted directly to the hub body in which there are arranged roller bearings with which the wheel hub can be rotated on an axial member with the brake disk connected.

This leads to a substantial loading on the bearings, which accelerates the aging process of the bearing grease. Even a spontaneous failure of the bearing lubrication has already been established with the resultant consequences with respect to corresponding repair work.

In order to provide a remedy in this regard, to prevent torsion of the brake disk, which does not then have a collar, positive-locking elements are used in the form of an internal tooth arrangement on the inner periphery of the brake disk and an outer tooth arrangement of the wheel hub in engagement therewith. Intermediate elements are provided in the interface of the brake disk with respect to the wheel hub by means of which a thermal conductivity in the wheel hub is reduced. Such a connection is known, for example, from DE 10 2009 041 953 A1.

Another solution to the problem is proposed in EP 2 066 503 B1 in which the teeth of the external tooth arrangement of the wheel hub are arranged with spacing from the hub body, with a gap being formed. However, this construction is very complex and can only be implemented with considerable construction complexity.

This applies equally to a connection as disclosed in EP 0 849 487 A2 wherein the brake disk has a formed-on neck which is in abutment with the hub body outside the wheel bearings.

In this instance, in the same manner as in the constructions mentioned above, in which the brake disk is retained on the hub body in a torsion-resistant manner by means of positive-locking elements, the wheel carrier and the hub body are constructed integrally as a casting, wherein, as a result of the high loads, the wheel carrier is produced from high-strength spheroidal graphite cast iron. In contrast, as a result of the good thermal conductivity, the brake disk is produced from grey cast iron.

An object of the invention is to develop an arrangement of the generic type in such a manner that its service-life is increased by improving the thermal insulation, as well as the operational reliability.

As a result of the separate construction of the wheel carrier with respect to the hub body, it is now possible, without significant additional structural and technical production complexity, to use a planar brake disk with internal teeth which engages for torsion-resistance with an external tooth arrangement of the wheel carrier.

To this end, the wheel carrier has a preferably integrally formed-on neck portion, on the outer covering face of which the teeth of the external tooth arrangement are formed. In principle, it is also conceivable to have separate construction of the wheel carrier and the neck portion which can then, for example, be connected to each other by a screw connection or in a materially engaging manner.

The securing of the wheel carrier to the hub body is carried out by screws which are guided through an inner crown of the wheel carrier and which are screwed into threaded holes at the end face of the hub body. There is thereby achieved a particularly robust securing which enables the wheel carrier to be in abutment with the hub body only with a small abutment face.

In principle, the advantages of the known internally toothed brake disk which are set out can be used, in particular with respect to the thermal insulation described in relation to the prior art.

Furthermore, the hub body with an integrated roller bearing may be used in an unmodified manner, as used when using a brake disk which is provided with a pot-like attachment since the end-face threaded holes are already present in the hub body.

Furthermore, the wheel carrier, including the connected neck portion, also as a separate component, may comprise high-strength spheroidal graphite cast iron, whilst the brake disk is produced from grey cast iron with a high level of thermal conductivity. With respect to grey cast iron, the thermal conductivity of spheroidal graphite cast iron is significantly lower. There is consequently additional protection from the action of heat on the hub body and consequently the roller bearings which are retained therein. The service-life of the roller bearings is thereby increased in a completely remarkable manner, which in turn results in a reduction of the operating costs.

Since a centering location is now dispensed with, there is a smaller imbalance of the mounted wheel, which can also be considered to a completely remarkable advantage.

As mentioned, it is possible to use the new connection with an already existing wheel hub, which carries the brake disk with a pot-like attachment. The described advantages of the invention, in particular with respect to the minimized thermal loading of the bearing locations, will consequently also be able to be used, for example, in the event of a brake disk being changed, when a disassembly of the brake disk and the wheel carrier is required. In such a situation, the new wheel carrier may be used, and has to be adapted only to the circumstances with regard to the dimensional calibration and configuration.

Furthermore, the invention enables the wheel carrier and the brake disk to be kept ready as a structural unit which is pre-assembled in the factory if, for example, the wheel hub is intended to be retrofitted with an arrangement according to the invention. Naturally, this thereby results in advantages in terms of assembly, which contribute to a cost reduction.

This is also the case with a brake disk change when the new arrangement is already operational since, as a result of disassembly of the structural unit, simpler access to the brake disk is possible in order to change it.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a sectioned side view of a connection between a wheel hub and a brake disk in accordance with an embodiment of the present invention,

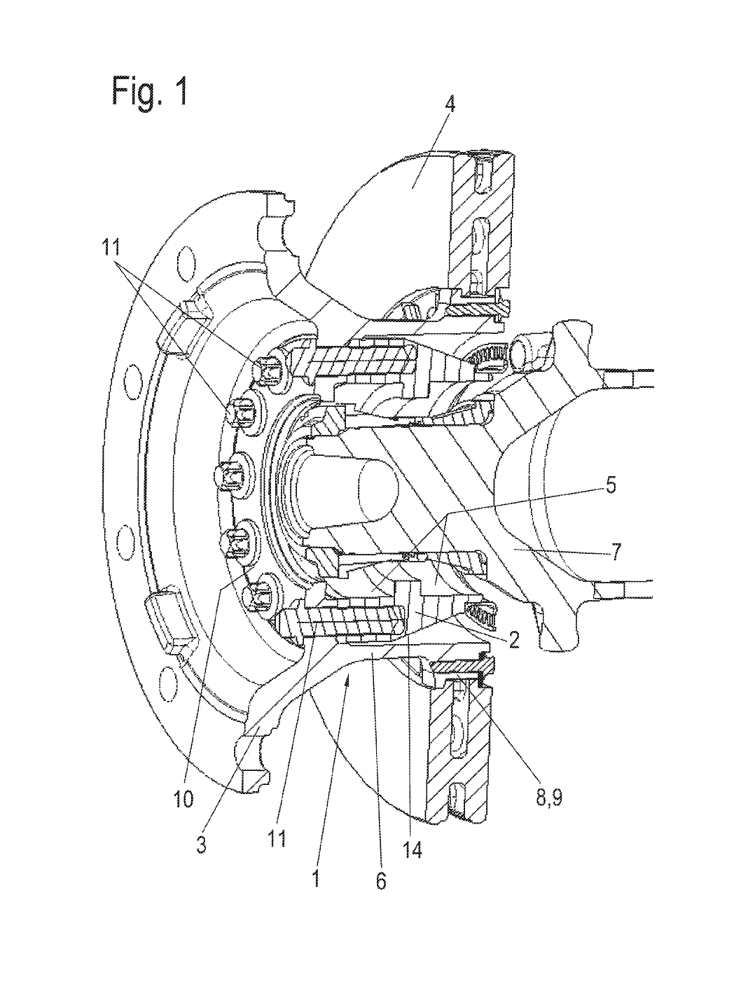

FIG. 2 is an exploded view of the connection of FIG. 1,

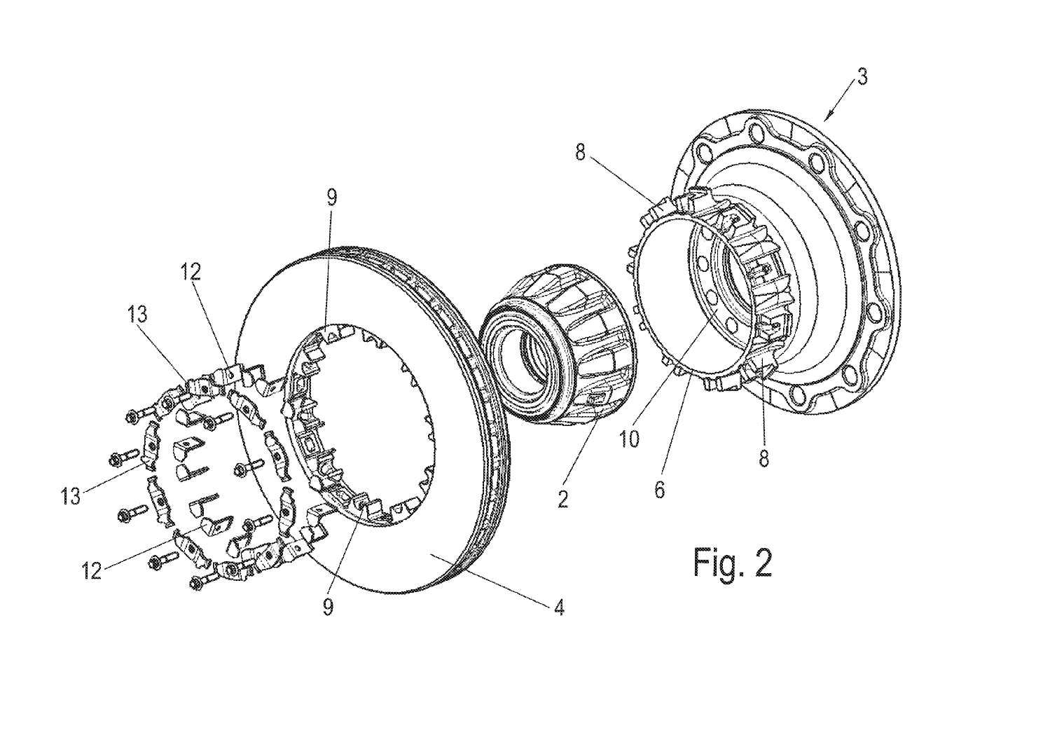

FIG. 3 is a perspective view of the connection of FIG. 1.

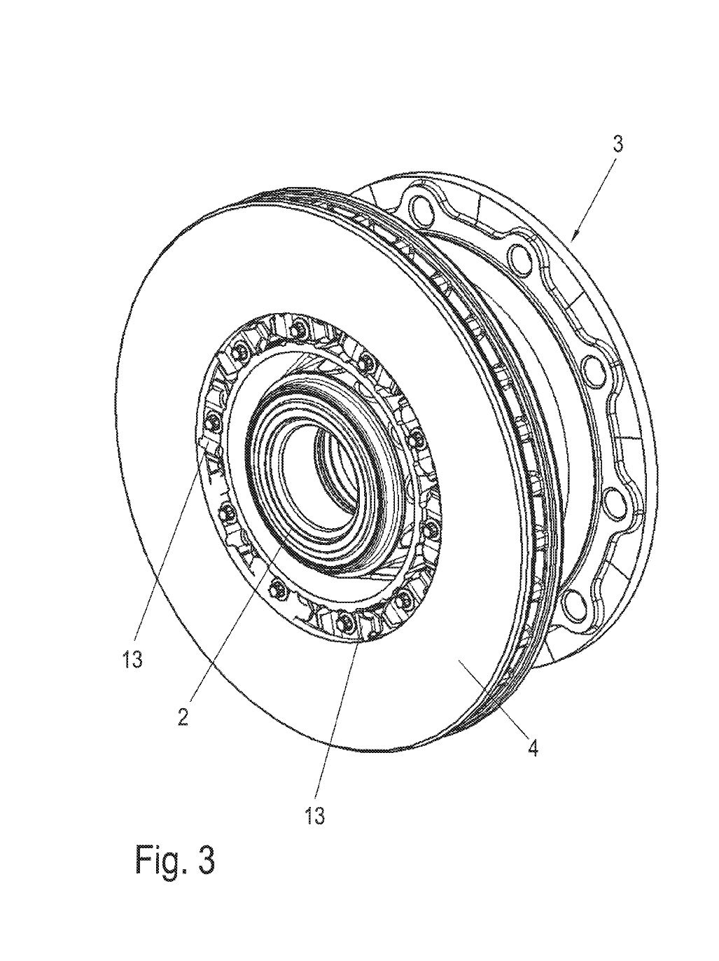

### DETAILED DESCRIPTION

The figures illustrate a torsion-resistant connection of a brake disk 4 to a wheel hub 1 of a utility vehicle. In this instance, the wheel hub 1 has a hub body 2 which is provided the inner periphery with bearing locations 5 for receiving roller bearings which are not illustrated so that the structural unit comprising wheel hub 1/brake disk 4 can be rotated on an axle member 7 which is fixed in this regard.

In order to retain a wheel, there is provided a wheel carrier 3 which, according to the invention, is connected to the hub body 2 as a separate component.

To this end, the wheel carrier 3 has on the inner periphery a continuous radially extending crown 10 with a large number of through-holes which are distributed over the periphery preferably with the same angular spacing with respect to each other and through which there are guided screws 11 which are screwed into corresponding threaded holes of the hub body 2, wherein these threaded holes are introduced into the hub body 2 at the end face.

The wheel carrier 3 has a cylindrical neck portion 6 which extends substantially concentrically relative to the hub body 2 and which extends in an axially parallel manner with respect to the hub body 2 and on the outer covering face of which there are formed external teeth 8 which are distributed over the periphery and which protrude with respect to the covering face.

The neck portion 6 which is cylindrical in the example is in abutment with the hub body 2 only with a peripheral edge region adjacent to the crown 10 so that a gap 14 is formed in the remaining covering region. A heat transfer from the wheel carrier 3 to the hub body 2 is consequently minimized.

Internal teeth 9 which are arranged on the inner periphery of the brake disk 4 which is further internally ventilated engage in the tooth gaps which are formed between the external teeth 8 of the neck portion 6.

A positive-locking connection is thereby produced for the torsion-resistant connection of the brake disk 4 to the wheel hub 1

Intermediate elements 12 are inserted as thermal insulation between the external teeth 8 of the wheel carrier 3 and the internal teeth 9, with a gap being formed by which a direct heat transfer between the external and internal teeth 8, 9 which correspond to each other is prevented. Furthermore, the intermediate elements 12 also serve to compensate for tolerance.

In order to axially secure the brake disk 4, there are provided securing elements 13 in the form of leaf springs which are screwed to the external teeth 8 of the wheel carrier 3.

In principle, other securing means are also conceivable, by which the brake disk 4 is secured to the wheel carrier 3 in a torsion-resistant manner.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A brake and hub arrangement of a utility vehicle, comprising:
a brake disc;
a wheel hub having a hub body configured to receive at least one roller bearing; and
a wheel carrier having a neck portion configured to be mounted on and at least partially surround the hub body and to support the brake disc,
wherein
the brake disk is retained on the wheel carrier in a positive-locking, torsion-resistant manner in a circumferential direction,
the wheel carrier has an radially-inward extending crown with apertures configured to receive fasteners, and
the hub body has an end-face with holes configured to receive the fasteners to mount the wheel carrier to the wheel hub.

2. The arrangement as claimed in claim 1, wherein
the neck portion is configured to abut a peripheral edge region of an outer side of the hub body.

3. The arrangement as claimed in claim 2, wherein
when the wheel carrier is mounted on the wheel hub, an annular gap is present between the neck portion and the hub body along at least a portion of an axial length of the hub body.

4. The arrangement as claimed in claim 3, wherein
the neck portion has external teeth arranged circumferentially with tooth gaps between adjacent pairs of the external teeth, the tooth gaps being configured to receive internal teeth on an inner circumference of the brake disk.

5. The arrangement as claimed in claim 4, wherein
the external and internal teeth have equal circumferential angular spacing.

6. The arrangement as claimed in claim 4, further comprising:
intermediate elements arranged between the external and internal teeth, the intermediate elements being configured to retain the brake disc on the wheel carrier.

7. The arrangement as claimed in claim wherein
the brake disk is formed from grey cast iron and the wheel carrier is formed from spheroidal graphite cast iron.

8. A brake disc and wheel carrier assembly, comprising:
a brake disc;
a wheel carrier; and
intermediate elements,
wherein
the wheel carrier has
an radially-inward extending crown with apertures configured to receive a plurality of fasteners and to couple the wheel carrier to an end face of a hub body of a wheel hub when the wheel carrier is in an installed position on the wheel hub,
a neck portion configured to be mounted on and at least partially surround the hub body and to abut a peripheral edge region of an outer side of the hub body when the wheel carrier is in an installed position on the hub body,
external teeth arranged circumferentially with tooth gaps between adjacent pairs of the external teeth configured receive internal teeth at an inner circumference of the brake disk to and to support the brake disc in a positive-locking, torsion-resistant manner in a circumferential direction
the brake disk is mounted on the wheel carrier and retained on the wheel carrier by the intermediate elements.
